(19) United States
(12) Patent Application Publication
(10) Pub. No.: US 2006/0208201 A1
(43) Pub. Date: Sep. 21, 2006

(54) Apparatus and method for substrate neutralization and glass substrate charging prevention

(75) Inventors: Yoshinori Hosokawa, Kyotanabe-shi (JP); Shigeo Okamoto, Kyoto-Shi (JP); Masayuki Masuda, Nishinomiya-shi (JP); Haruyuki Koizumi, Kyoto-shi (JP)

Correspondence Address: Baker & Daniels, Suite 700, 805 15th Street, N.W., Washington, DC, 20005, US

(73) Assignee: Omron Corporation, Kyoto-shi (JP)

(21) Appl. No.: 11/374,135

(22) Filed: Mar. 14, 2006

(30) Foreign Application Priority Data
Mar. 15, 2005 (JP) JP2005-073571

(51) Int. Cl. G21G 5/00; G01N 23/00

(52) U.S. Cl. 250/492.1; 378/1

(57) ABSTRACT

A neutralizing method and a neutralizing apparatus for effectively neutralizing an insulating member in a simple and efficient way are disclosed. A hard X-ray generating device radiates a hard X-ray on the obverse surface of the insulating member from the direction perpendicular to the obverse surface of the insulating member. The hard X-ray generating apparatus radiates a hard X-ray having the wavelength of not less than 0.05 Å but less than 1 Å. The hard X-ray ionizes the air on the obverse surface of the insulating member and neutralizes the charge on the obverse surface of the insulating member, while at the same time neutralizing the charge on the reverse surface of the insulating member by the X-ray transmitted through the insulating member.

### BACKGROUND OF THE INVENTION

1. Field of the Invention

This invention relates to a method and an apparatus for neutralizing an insulative substrate, and a method and an apparatus for preventing the charging of the insulative substrate,

2. Description of the Related Art

In the conventional process of producing a glass substrate used for a liquid crystal display, electrons are trapped in the incompletely combined parts of atoms due to the friction with the conveyor belt surface during transportation or at the time of separation by a vacuum chuck. Also, the insulative substrate may be charged to positive or negative polarity by ionization of atoms.

Once the glass substrate is charged, the surrounding particles are adsorbed to or deposited on the substrate often causing the problem of dielectric breakdown of various thin films. Also, in the case where a liquid crystal display is fabricated using a charged glass substrate, the starting voltage of the liquid crystal display is changed by the charge on the glass substrate, thereby posing the problem that the brightness of the liquid crystal screen changes.

Conventionally, in view of these problems, the glass substrate or the like insulating member is neutralized by a method using the corona discharge or the soft X-ray. In the neutralizing method using the corona discharge, positive and negative ions are generated from a discharge electrode and applied to the glass substrate to neutralize the charge. In the neutralizing method using the soft X-ray (wavelength of not less than 1 Å), on the other hand, the air in the neighborhood of the insulating member is ionized by the soft X-ray and the charge of the insulating member is neutralized by the ionized air. Japanese Patent Application Laid-Open Nos. 11-214191, 2000-267106, 2002-257702 and 2004-299814 and Japanese Patent Publication No. 2749202 disclose a method of neutralizing an insulating member using the soft X-ray.

The neutralizing method using the corona discharge, however, raises dust when ions are applied and therefore finds no suitable application in an environment required to be kept clean. This method also poses the problem that the ionized air is recombined for a low neutralization performance.

FIGS. 8A-8C illustrate the conventional neutralizing method using the soft X-ray.

As shown in FIG. 8A, an insulating member can be neutralized by radiating the soft X-ray from a soft X-ray generating device 5# and ionizing the air in the soft X-ray radiation range.

The soft X-ray, though high in air ionization efficiency, is easily absorbed into the air, and therefore a sufficient distance cannot be secured from the insulating member to the soft X-ray source, resulting in a narrow neutralization area.

Also, the reverse surface of the glass substrate is charged by separation or friction when the glass substrate is lifted from the stage or transported, respectively, and the potential increases instantaneously at the time of separation. The neutralization, therefore, requires a space between the glass substrate and the stage into which the ionized air is sent or the soft X-ray is radiated.

In the case where the soft X-ray is radiated to the reverse surface of the glass substrate horizontally or specifically from the soft X-ray generating device 5#A on the right side and the soft X-ray generating device 5#B on the left side as shown in FIG. 8B, for example, the ionization concentration is greatly varied at a position distant from the vicinity of the soft X-ray tube for generating the soft X-ray, often resulting in neutralization variations.

An attempt to eliminate the neutralization variations and neutralize a wide area of the glass substrate, therefore, requires a multiplicity of soft X-ray generating devices 5# as shown in FIG. 8C. The multiplicity of soft X-ray generating devices requires additional expense and excessive maintenance time.

### SUMMARY OF THE INVENTION

Embodiments of the invention solve the problems described above, and an object of the invention is to provide a neutralizing method and a neutralizing apparatus capable of neutralizing an object such as an insulating member effectively in a simple and efficient way.

Another object of this invention is to provide a charging prevention method and a charging prevention apparatus for preventing object or insulating member from being charged when lifted up from the stage or transported.

According to one aspect of this invention, there is provided a neutralizing method in which the hard X-ray having the wavelength of not less than 0.05 Å but less than 1 Å is radiated directly on a charged object to be neutralized (hereinafter sometimes referred to simply as “the object”).

According to another aspect of the invention, there is provided a neutralizing method in which a hard X-ray generating device for generating a hard X-ray having the wavelength of not less than 0.05 Å but less than 1 Å is arranged at a position from which the hard X-ray can be radiated directly on the object, and the hard X-ray is so radiated.

In some preferred embodiments of the invention, the object is a glass substrate.

Specifically, the hard X-ray is radiated on the charged glass substrate directly from the direction perpendicular to an obverse surface thereof (or surface facing an observer,) and the reverse surface of the glass substrate is neutralized by the hard X-ray transmitted through the glass substrate.

According to still another aspect of the invention, there is provided a neutralizing method in which a glass substrate placed on or adjacent to a stage or platform is neutralized by being irradiated directly with the hard X-ray having the wavelength of not less than 0.05 Å but less than 1 Å from the direction perpendicular to the upper surface of the stage.

According to yet another aspect of the invention, there is provided a method of preventing the charging of a glass substrate, wherein a hard X-ray having the wavelength of not less than 0.05 Å but less than 1 Å is radiated directly on the upper surface of the stage from the direction perpendicular thereto while the glass substrate is lifted up from the upper surface of the stage.

According to a further aspect of the invention, there is provided a neutralizing apparatus comprising a stage on which a glass substrate is placed and a radiation mechanism for radiating a hard X-ray having the wavelength of not less than 0.05 Å but less than 1 Å directly on the insulating member or glass substrate. The insulating member or glass substrate may be placed on a support extending from the upper surface of the stage. The radiation may originate from the direction perpendicular to the upper surface of the stage.

According to a still further aspect of the invention, there is provided a charge prevention apparatus for a glass substrate or insulating member comprising a stage on which the glass substrate is placed and a radiation mechanism for radiating a hard X-ray having the wavelength of not less than 0.05 Å but less than 1 Å directly on the glass substrate placed above the upper surface of the stage. The radiation may originate from the direction perpendicular to the upper surface of the stage while the glass substrate is supported above the stage.

In the neutralizing method and apparatus according to this invention, a hard X-ray having the wavelength of not less than 0.05 Å but less than 1 Å is radiated on the object. The hard X-ray can ionize the gas in the neighborhood of the object from a position distant from the object, and therefore a wide neutralization area can be secured, and the neutralization can be effectively carried out in a simple and efficient way.

In the charge prevention method and apparatus according to this invention, a hard X-ray having the wavelength of not less than 0.05 Å but less than 1 Å is radiated directly on a glass substrate or insulating member when lifted up or separated by a distance from the upper surface of the stage. The hard X-ray, as compared with the soft X-ray, has a higher transmittance through the glass substrate, and therefore the reverse surface, in addition to the obverse surface, of the glass substrate can be neutralized by the transmitted X-ray, thereby preventing the charging by separation and friction.

### BRIEF DESCRIPTION OF THE DRAWINGS

FIG. 1 shows a general configuration of a neutralizing apparatus according to an embodiment of the invention;

FIG. 2 shows a configuration of a hard X-ray generating device for generating a hard X-ray;

FIG. 3 shows a schematic diagram for explaining a neutralizing method according to an embodiment of the invention;

FIG. 4 shows a diagram for explaining the comparison of the neutralization time between the soft X-ray and the hard X-ray radiated on an insulating member;

FIGS. 5A-5C show diagrams for explaining the transmittance of a glass substrate irradiated with the soft X-ray and the hard X-ray;

FIGS. 6A and 6B show diagrams for explaining the measurement of the potential of the reverse surface of a glass substrate with the hard X-ray and the soft X-ray radiated on the obverse surface of the glass substrate;

FIGS. 7A and 7B show a distribution of excitation of metal materials forming a glass substrate irradiated with the X-ray; and

FIGS. 8A-8C show diagrams for explaining the conventional neutralizing method using the soft X-ray.

### DETAILED DESCRIPTION OF THE PREFERRED EMBODIMENTS

Embodiments of this invention are described in detail below with reference to the drawings. In the drawings, the same or equivalent component elements are designated by the same reference numerals, respectively, and not explained repeatedly.

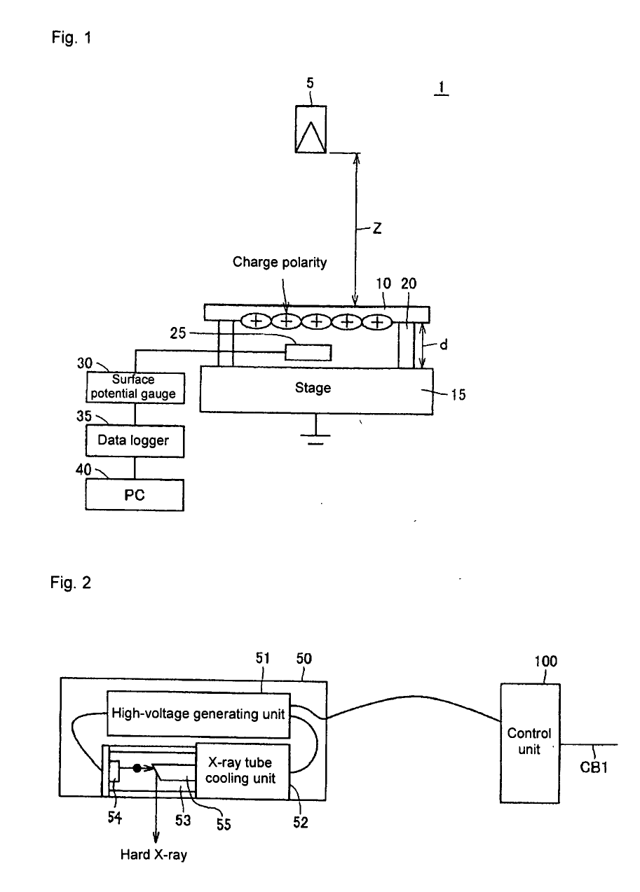

FIG. 1 shows a general configuration of a neutralizing apparatus 1 according to an embodiment of the invention.

Referring to FIG. 1, the neutralizing apparatus according to an embodiment of the invention comprises a hard X-ray generating device 5 and a stage 15 grounded to support an insulating member 10 that functions as an object to be neutralized. A support member 20 of plastics or the like may be provided to hold the insulating member 10 at a distance d from the upper surface of the stage 15. A sensor 25 may be connected with a surface potential gauge 30 and may measure the surface potential of the insulating member 10. A data logger 35 and a control unit (PC) 40 may also be provided. The sensor 25 is adapted to measure the surface potential of a reverse surface of the insulating member 10. The reverse surface of the insulating member 10 is the surface opposite a surface facing the observer or an obverse surface. The surface potential gauge 30 measures the surface potential from the charge generated in the insulating member 10 and induced to the sensor 25. The method for measuring the surface potential is generally known and not described in detail.

The hard X-ray generating device 5 and the insulating member 10 are arranged in spaced relation to each other with a distance Z therebetween. In this position, the hard X-ray is radiated directly from the direction perpendicular to the upper or obverse surface of the insulating member 10. The insulating member 10 is assumed to be in a charged state. In this embodiment, a glass substrate for a liquid crystal display (hereinafter referred to also as the LCD glass substrate) or a glass substrate for a plasma display (hereinafter referred to also as the PDP glass substrate) is used as an example of the insulating member 10.

In the neutralizing method according to this embodiment of the invention, the insulating member 10 is neutralized by the hard X-ray directly radiated thereon.

FIG. 2 shows a configuration of the hard X-ray generating device 5 for generating the hard X-ray.

Referring to FIG. 2, in the displayed embodiment, the hard X-ray generating device 5 includes a control unit 100 for controlling a hard X-ray generating unit 50. Thus, the hard X-ray generating unit 50 generates the hard X-ray based on an instruction from the control unit 100. The control unit 100 is connected to an external power supply through a cable CB1 and is supplied with a voltage required to drive the hard X-ray generating unit 50. The control unit 100 outputs a control signal to control the hard X ray generating unit 50. The hard X-ray generating unit 50 includes a high voltage generating unit 51, an X-ray tube cooling unit 52, an X-ray tube 53 and a protective case that may be formed of lead. The X-ray tube 53 includes a filament 54 and a target 55 formed of a metal material such as tungsten. The high-voltage generating unit 51 supplies a filament current to the filament 54 of the X-ray tube 53 and applies a high voltage to the target 55 formed of a metal material such as tungsten. At the same time, thermal electrons jump out toward the target 55 from the filament 54 supplied with the filament current. The thermal electrons impinge on the target 55 thereby to generate an X-ray. The hard X-ray generating device 5 according to this embodiment is for generating a hard X-ray having a wavelength of not less than 0.05 Å but less than 1 Å. The wavelength of not less than 0.05 Å but less than 1 Å of this hard X-ray is included within the wavelength range of the hard X-ray that can be actually used for neutralization of the glass substrate.

The protective case is formed with an aperture, from which the X-ray is radiated outside. Also, 99% of the kinetic energy of the thermal electrons emanating from the filament 54 is converted to heat, which can be cooled by the X-ray tube cooling unit 52 pneumatically or hydraulically.

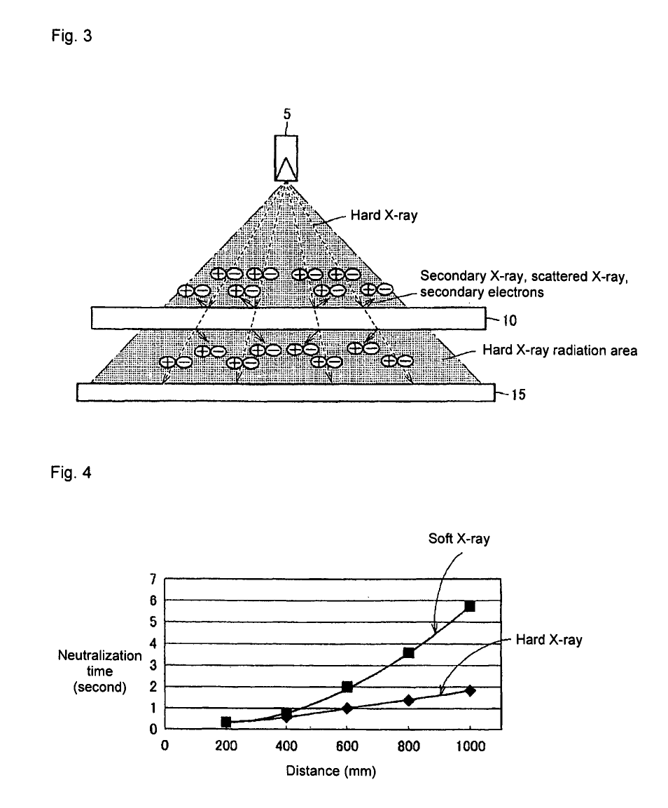

FIG. 3 is a schematic diagram for explaining a neutralizing method according to an embodiment of the invention.

In the neutralizing method according to this embodiment of the invention shown in FIG. 3, the hard X-ray is radiated on the insulating member 10 from the hard X-ray generating device 5.

The hard X-ray radiated from the hard X-ray generating device 5 is absorbed into the air and generates ions. At the same time, the ions generated in the neighborhood of the insulating member 10 are neutralized by reacting with the charge of the insulating member 10.

Unlike the soft X-ray, the hard X-ray is directly radiated on the insulating member 10 and generates the secondary electrons, the secondary X-ray and the scattered X-ray in accordance with the atomic number of the insulating member 10 thereby to ionize the air in the neighborhood of the insulating member 10. Specifically, the radiation of the hard X-ray generates the secondary X-ray, the scattered X-ray and the secondary electrons from the transition elements, the light elements and the heavy elements contained in the insulating member 10. These X-rays and electrons also contribute to the generation of ions by reacting with the air. The ions thus generated neutralize the charge of the insulating member 10 by reaction therewith. In this way, the neutralization effect is further enhanced by the secondary X-ray, the scattered X-ray and the secondary electrons in addition to the hard X-ray.

Also, the electric dissociation of the solid insulating member 10 neutralizes the charge of the insulating member 10 by solid ionization. Specifically, the hard X-ray passed through the glass substrate ionizes and shorts the glass or other insulating material. As a result, the residual charge in the substrate can be removed.

X-ray According to an embodiment of the invention, the hard X-ray has a higher energy than the soft X-ray, and therefore is not easily absorbed into the air. Thus, a longer distance can be secured from the insulating member 10 to the hard X-ray generating device 5 than the corresponding distance from the insulating member 10 to the soft X-ray generating device. Accordingly, assuming the radiation angle from the X-ray tube is equal in both scenarios, a wider radiation area (neutralization area) can be secured through the hard X-ray than by the soft X-ray.

FIG. 4 is a diagram for explaining the comparison of the neutralization time between the soft X-ray and the hard X-ray radiated on the insulating member 10.

As shown in FIG. 4, in the case where the distance between the X-ray generating device and the insulating member 10 is short, the soft X-ray absorbed into the air at higher rate can generate ions more effectively, and the neutralization can be carried out for a period substantially as short as that for the hard X-ray.

As shown in FIG. 4, however, as the distance becomes greater, more soft X-ray absorption into the air occurs over a short distance and ions are generated at a lesser rate in the neighborhood of the insulating member 10. Accordingly, in this situation, a longer time period is required for neutralization with the soft X-ray than for the hard X-ray. For the distance Z of about 1000 mm, for example, the neutralization time is 6 seconds for the soft X-ray, while it is 2 seconds for the hard X-ray. The neutralization method using the hard X-ray, therefore, is expected to produce a sufficient neutralization effect even for a wider radiation range.

Further, the hard X-ray radiated from the hard X-ray generating device 5 is transmitted through the insulating member 10. Therefore, the hard X-ray that has been transmitted through the obverse surface of the insulating member 10 reacts with the air on the reverse surface to generate ions. The air in the neighborhood of the reverse surface of the insulating member 10 is ionized by the transmitted hard X-ray, and therefore, the charge on the reverse surface of the insulating member 10, which may be a glass substrate or the like, is neutralized.

Specifically, by radiating the hard X-ray only from one side of the insulating member 10 such as a glass substrate, the reverse surface and the obverse surface of the insulating member can be neutralized at the same time.

The secondary X-ray, the scattered X-ray and the secondary electrons are generated also from the hard X-ray radiated on the reverse surface, and as in the aforementioned case, react with the air to generate ions. These ions generated are neutralized by reaction with the charge on the reverse surface of the insulating member 10.

The transmittance of the glass substrate is explained with reference to the radiation of the soft X-ray and the hard X-ray.

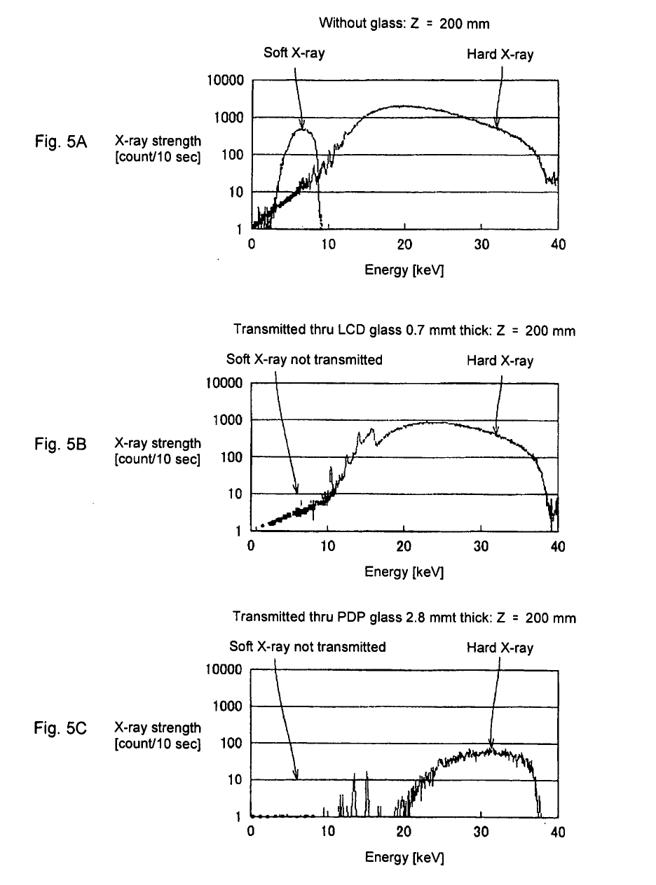

FIG. 5A shows the X-ray strength without considering the glass substrate or other insulating member. In this case, the distance Z of the X-ray generating device is set to 200 mm.

FIG. 5B shows a case in which a LCD glass substrate is arranged and the transmittance thereof is measured. The thickness of the LCD glass substrate is about 0.7 mm.

The soft X-ray is low in energy and therefore the transmittance thereof through the LCD glass is very low.

FIG. 5C shows a case in which a PDP glass substrate is arranged, and the transmittance thereof is measured. In this case, the thickness of the PDP glass substrate is about 2.8 mm.

Also in this case, the soft X-ray is low in energy and therefore the transmittance thereof through the PDP glass is so low that only the hard X-ray is measurable,

The hard X-ray is transmitted through the LCD glass (0.7 mm) or the PDP glass (2.8 mm), and therefore the reverse surface of the glass substrate can be neutralized by the hard X-ray transmitted through the insulating member.

In the case where a secondary excitation plate is provided to facilitate the generation of the secondary electrons, the secondary X-ray and the scattered X-ray are arranged to face the reverse surface of the insulating member. The X-ray transmitted through the insulating member impinges on the secondary excitation plate, and the air around the reverse surface of the object is ionized by the secondary X-ray, the scattered X-ray and the secondary electrons thus generated, thereby making a more effective neutralization possible.

In the case where the obverse surface of the insulating member is charged, such as when the glass substrate is wetted with water after the cleaning step, the radiation of the soft X-ray reduces the surface potential of the obverse surface of the insulating member to substantially 0 V. Due to the presence of static inductance on the reverse surface of the glass substrate, however, a reverse surface potential of several tens to several hundreds of volts may be generated or a potential may be generated on the obverse surface thus far at 0 V by the radiation of the soft X-ray. In such a case, the charge on the obverse surface of the glass substrate may not be completely neutralized by the soft X-ray due to the wet condition.

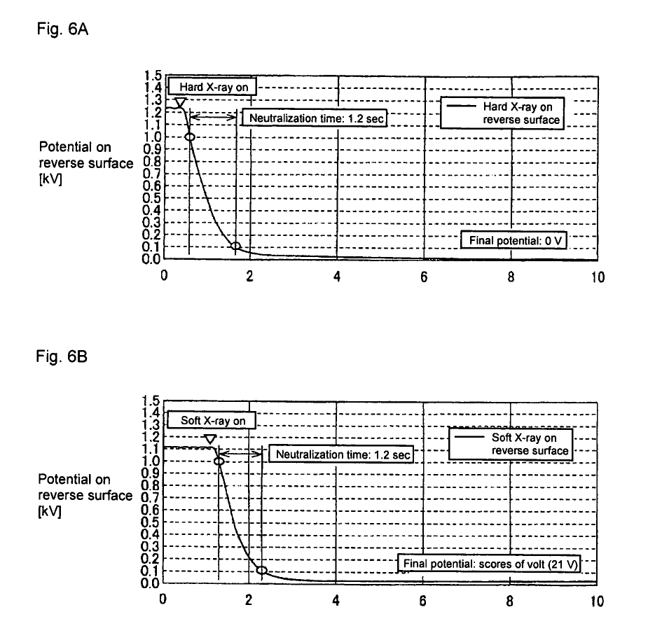

FIGS. 6A and 6B are diagrams for explaining a case in which the potential of the reverse surface of the glass substrate is measured upon radiation of the hard X-ray and the soft X-ray on the obverse surface of the glass substrate. In this case, the potential of the reverse surface is measured using the sensor 25 shown in FIG. 1.

As shown in FIGS. 6A and 6B, the neutralization time is substantially the same for both the hard and soft X-rays. The neutralization with the soft X-ray, however, leaves a potential of 21 V. In the neutralization with the soft X-ray, therefore, both the obverse and reverse surfaces of the charged glass substrate cannot be completely neutralized. The use of the hard X-ray, on the other hand, can completely neutralize both the obverse and reverse surfaces with the potentials thereof reduced to zero V.

Furthermore, in the case where the hard X-ray is used, the obverse and reverse surfaces of the glass can be neutralized regardless of the wet condition of the glass.

In the case where the glass substrate is lifted up from the stage or transported, the charging is caused by separation or friction, as the case may be, on the reverse surface of the glass substrate, and the potential may instantaneously increase at the time of separation. Especially in the case where the soft X-ray is used, the residual charge and the closely attached state of the glass substrate on the stage makes it difficult to secure a spatial interval for sending ionized air or radiating the soft X-ray. In the case where the hard X-ray is used, in contrast, the transmitted X-ray, the secondary electrons, the secondary X-ray and the scattered X-ray are generated under the reverse surface of the insulating member. Therefore, the charging by separation and friction which otherwise might be caused at the time of separation is prevented thereby to suppress the instantaneous potential rise of the glass substrate.

As a result, the charging of the glass substrate by separation and friction can be prevented by radiating the hard X-ray on the glass substrate when lifted up or transported.

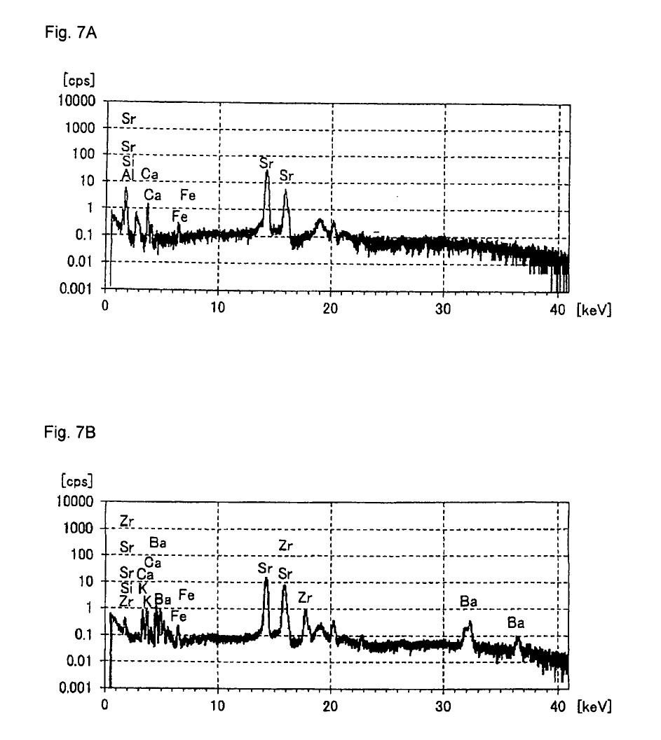

FIGS. 7A and 7B are diagrams showing the distribution of excitation of metal materials forming the glass substrate in the case where the X-ray is radiated on the glass substrate.

FIG. 7A shows the metals, Al, Si, Ca, Fe, Sr, making up the LCD glass substrate in the ascending order of the element number. The energy of the soft X-ray is at most about 10 keV, and therefore the metal Sr cannot be excited.

FIG. 7B shows the case of the PDP glass substrate in which the metals Si, K, Ca, Fe, Sr, Zr, Ba making up the PDP glass substrate appear in the ascending order of the element number. As described above, the energy of the soft X-ray is 10 keV, and therefore the metals Sr, Zr, Ba which are excited by the energy higher than 10 keV cannot be excited.

By radiating the hard X-ray having the wavelength of less than about 1 Å (with the energy of not less than 12.4 eV), the secondary electrons, the secondary X-ray and the scattered X-ray are generated for all of the listed metals including those which cannot be excited by the soft X-ray. Accordingly, a higher neutralization effect than with the soft X-ray is expected. The higher energy of the X-ray and the shorter wavelength thereof, require a larger scale of the shield structure. Taking these facts and the necessity of the X-ray to reach the reverse surface of the PDP glass substrate with the minimum X-ray transmittance into consideration, the proper wavelength of the X-ray is considered to be not less than 0.05 Å.

In the neutralizing method according to an embodiment of the invention using a hard X-ray high in energy, as compared with a case using the soft X-ray low in energy, the neutralization can be carried out sufficiently even in the case where the radiation distance is long or the radiation angle is widened for a larger radiation range. As a result, the number of the hard X-ray generating devices required to neutralize the insulating member of a large size such as a glass substrate can be reduced, thereby facilitating the maintenance and installation while at the same time decreasing the total cost.

Also, generally, the X-ray tube for generating the soft X-ray has a beryllium window as an X-ray window member high in soft X-ray transmission efficiency. However, beryllium, which is a harmful material and therefore essentially requires management including recovery to ensure safety and protect the environment, is required to be handled with care.

The X-ray tube for generating the hard X-ray, on the other hand, uses no harmful material and therefore can be handled and recovered advantageously from the viewpoint of safety and environmental protection.

In the embodiments described above, an experiment is conducted by applying a high voltage of 40 kV as a tube voltage 53 with a filament current of 0.6 mA in order to radiate the hard X-ray. Nevertheless, the invention is not limited to these figures and a similar effect can be secured by adjusting the numerical values in accordance with the thickness of the insulating member, etc.

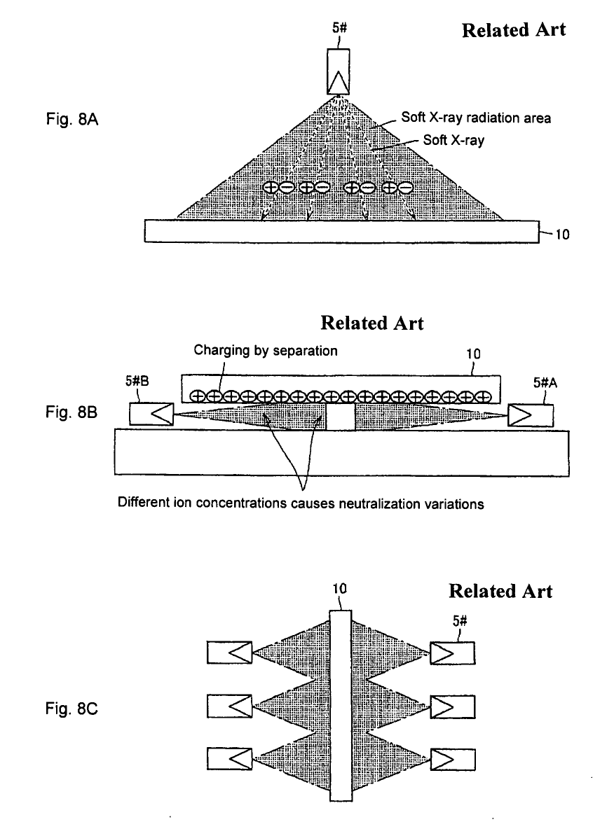

Also, in the foregoing description of the embodiments, the hard X-ray is radiated from the direction perpendicular to the obverse surface of the glass substrate to neutralize also the charge on the reverse surface by the transmitted X-ray. This invention, however, is not limited to this configuration, and the hard X-ray can be radiated on the reverse surface from the hard X-ray generating devices located on the right and left sides, respectively, as shown in FIG. 8B. In this case, due to the long effective radiation distance of the hard X-ray, the reverse surface can be effectively neutralized without any neutralization variations. In this way, the number of the hard X-ray generating devices to be installed can be reduced, and a high economical effect is expected due to a lower installation cost and maintenance frequency.

In the description above, the LCD glass and the PDP glass are cited as an example. This invention is not limited to the use of these types of glass and is applicable also to the neutralization of SED (surface-conduction electron-emitter display), an organic EL (organic electroluminescence display), FPD (flat panel display) and various other insulative solid or liquid materials including copy paper and packaging and packing materials.

Further, the case of enlarging the radiation range by lengthening the radiation distance and widening the radiation angle is explained above. As an alternative, the radiation range is narrowed by a bundle of thin hard X-ray beams using the collimator, slit or the capillary, and by thus limiting the neutralization area of a solid, liquid or gas, the neutralizing method described above can be used only for the desired area. Further, a great variety of charge prevention and neutralizing methods can be implemented in keeping with the user needs by spatially and temporally controlling the beams.

The embodiments disclosed above should be considered illustrative in all respects but not limiting. The scope of this invention is defined not by the foregoing description but by the appended claims, and intended to include all the changes within the meaning and scope equivalent to the claims.

What is claimed is:

1. A neutralizing method for neutralizing a charged object, the neutralizing method comprising:
radiating a hard X-ray having a wavelength of not less than 0.05 Å but less than 1 Å directly on the charged object to be neutralized.

2. A neutralizing method for neutralizing an object, the method comprising:
implementing a hard X-ray generating device for generating a hard X-ray having a wavelength of not less than 0.05 Å but less than 1 Å, the hard X-ray generating device located at a position from where the hard X-ray can be radiated directly on the object to be neutralized, and
radiating the hard X-ray directly on the object to be neutralized.

3. A neutralizing method according to claim 1,
wherein the charged object to be neutralized comprises to a glass substrate.

4. A neutralizing method according to claim 3, further comprising
radiating the hard X-ray directly on an obverse surface of a charged glass substrate from the direction perpendicular to the obverse surface of the glass substrate, and
neutralizing the reverse surface of the glass substrate by the hard X-ray transmitted through the glass substrate.

5. A neutralizing method for neutralizing a glass substrate, the neutralizing method comprising:
directly irradiating a glass substrate placed adjacent to an upper surface of a stage with a hard X-ray having the wavelength of not less than 0.05 Å but less than 1 Å from the upper surface of the stage; and
irradiating in the direction perpendicular to the upper surface of the stage.

6. A charge prevention method for preventing charge accumulation on a glass substrate, the method comprising:
directly radiating a hard X-ray having a wavelength of not less than 0.05 Å but less than 1 Å on the glass substrate placed adjacent an upper surface of a stage, from a direction perpendicular to the upper surface of the stage, while the glass substrate is separated from the stage.

7. A neutralizing apparatus comprising:
a stage on which a glass substrate is placed; and
a radiation device for radiating a hard X-ray having a wavelength of not less than 0.05 Å but less than 1 Å directly on the glass substrate placed on an upper surface of the stage, from the direction perpendicular to the upper surface of the stage.

8. A charge prevention apparatus for a glass substrate comprising:
a stage on which the glass substrate is placed; and
a radiation device for radiating a hard X-ray having the wavelength of not less than 0.05 Å but less than 1 Å directly on the glass substrate placed adjacent to an upper surface of the stage, from a direction perpendicular to the upper surface of the stage, while the glass substrate is separated from the upper surface of the stage.
